(19) United States
(12) Patent Application Publication
(10) Pub. No.: US 2010/0271806 A1
(43) Pub. Date: Oct. 28, 2010

(54) BACK LIGHT UNIT AND DISPLAY DEVICE USING THE SAME

(75) Inventors: Seung Choon Bae, Pyeongtaek-si (KR); Seung Se Kim, Pyeongtaek-si (KR); Hoon Hur, Pyeongtaek-si (KR)

Correspondence Address: KED & ASSOCIATES, LLP, P.O. Box 221200, Chantilly, VA, 20153-1200, US

(73) Assignee: LG Electronics Inc., Seoul (KR)

(21) Appl. No.: 12/727,966

(22) Filed: Mar. 19, 2010

(30) Foreign Application Priority Data
Apr. 27, 2009 (KR) 10-2009-0036472
Oct. 16, 2009 (KR) 10-2009-0098901

(51) Int. Cl. G02F 1/13357

(52) U.S. Cl. 362/97.1

(57) ABSTRACT

A back light unit may provided that includes a board, a light source on the board, a plurality of light guide plates provided in a neighboring state, and an attachment member on a light incidence part of the light guide plate to attach the light guide plate to a frame, or an attachment member to block light from a light incidence part.

### CROSS-REFERENCE TO RELATED APPLICATIONS

This application claims priority under 35 U.S.C. 5119 and 35 U.S.C. §365 to Korean Applications Nos. 10-2009-0036472 filed on Apr. 27, 2009, 10-2009-0098901 filed on Oct. 16, 2009 whose entire disclosures are incorporated herein by reference.

### BACKGROUND

1. Field

Embodiments of the present disclosure may relate to a back light unit for emitting light and a display device using the same.

2. Background

A liquid crystal display (LCD), which is a kind of display, may be used in various devices, such as televisions, laptop computers, monitors for desktop computers, and/or mobile phones.

The LCD may not self-emit light. Accordingly, a light emitting device for illuminating a liquid crystal panel may be used to display image information.

The light emitting device of the LCD may be coupled to a bottom of the liquid crystal panel. Accordingly, the light emitting device of the LCD may be called a back light unit. The back light unit may form a uniform planar light source for emitting light to the liquid crystal panel.

The back light unit may include a light source, a light guide plate, a diffusion sheet, a prism, and/or a protection sheet. A fluorescent lamp, such as a cold cathode fluorescent lamp (CCFL), and/or a light emitting diode may be used as the light source.

### BRIEF DESCRIPTION OF THE DRAWINGS

Arrangements and embodiments may be described in detail with reference to the following drawings in which like reference numerals refer to like elements and wherein:

FIG. 1 is an exploded view illustrating a back light unit according to an embodiment of the present disclosure;

FIG. 2 is a sectional view illustrating an example of a light guide plate;

FIG. 3 is a sectional view illustrating an example of a frame;

FIG. 4 is a perspective view illustrating an example of an cover;

FIG. 5 is a plan view illustrating a light emitting surface of a back light unit;

FIG. 6 is an exploded view illustrating a back light unit according to an embodiment of the present disclosure;

FIG. 7 is a perspective view illustrating an embodiment of a frame;

FIG. 8 is a sectional view illustrating an example of an cover;

FIG. 9 is a sectional view illustrating a coupling using the cover of FIG. 8;

FIG. 10 is a sectional view illustrating an example of an cover;

FIG. 11 is a sectional view illustrating a coupling using the cover of FIG. 10;

FIG. 12 is a sectional view illustrating an example of a cover;

FIG. 13 is a sectional view illustrating an example of coupling a reflection plate to a light guide plate;

FIG. 14 is an exploded view illustrating an example of a display device;

FIG. 15 is a sectional view illustrating an example of a display panel;

FIG. 16 is a block diagram illustrating a liquid crystal television including a display device;

FIG. 17 is a partial perspective view illustrating an example of an attachment member;

FIG. 18 is a partial perspective view illustrating an embodiment of an insertion part;

FIG. 19 is a partial perspective view illustrating an embodiment of an insertion part; and

FIG. 20 is a partial sectional view illustrating a structure of a light guide plate fixed by an attachment member.

FIG. 21 is a perspective view illustrating the structure of a light source unit;

FIG. 22 is a perspective view illustrating arrangement of the light source unit and a reflection member;

FIG. 23 is a plan view illustrating the structure of a frame;

FIG. 24 is a perspective illustrating the structure of a back light unit;

FIG. 25 is a view illustrating arrangement of light guide plates and light source units mounted to the frame;

FIG. 26 is a view illustrating a relationship between the back light unit and optical sheets; and

FIG. 27 is a perspective view illustrating another embodiment of a light guide plate.

### DETAILED DESCRIPTION

Embodiments of the present disclosure may now be described more fully hereinafter with reference to the accompanying figures, in which embodiments are shown. While embodiments may be susceptible to various modifications and alternative forms, specific embodiments thereof are shown by way of example in the drawings. However, embodiments should not be construed as limited to the embodiments set forth herein, but on the contrary, embodiments of the present disclosure may cover all modifications, equivalents, and alternatives falling within the spirit and scope of the invention as defined by the claims.

It may be understood that when an element such as a layer, region and/or substrate is referred to as being “on” another element, it may be directly on the other element or intervening elements may also be present.

It may be understood that, although the terms first, second, etc. may be used herein to describe various elements, components, regions, layers and/or regions, these elements, components, regions, layers and/or regions should not be limited by these terms.

In embodiments, light guide plate modules each including a side view light source unit and a light guide plate may be connected to each other in a neighboring state to reduce thickness of a back light unit, thereby providing a large-sized back light unit.

For a large-sized television, when a single light guide plate is provided over a whole screen and light sources are provided adjacent to the light guide plate, optical or thermal efficiency may be lowered due to spatial limitations in light source arrangement.

On the other hand, when light guide plates are manufactured so as to have a small size, light sources may be provided at sides of the light guide plates, and the respective light guide plates may be connected to each other, and a sufficient amount of light may be secured and heat may be scattered. The light sources provided at sides of the light guide plates may be optically hidden, thereby providing uniform light.

Small module type light guide plates may be connected to each other such that the light sources are provided between the light guide plates. A plurality of identical light guide plates may be arranged irrespective of sizes of televisions.

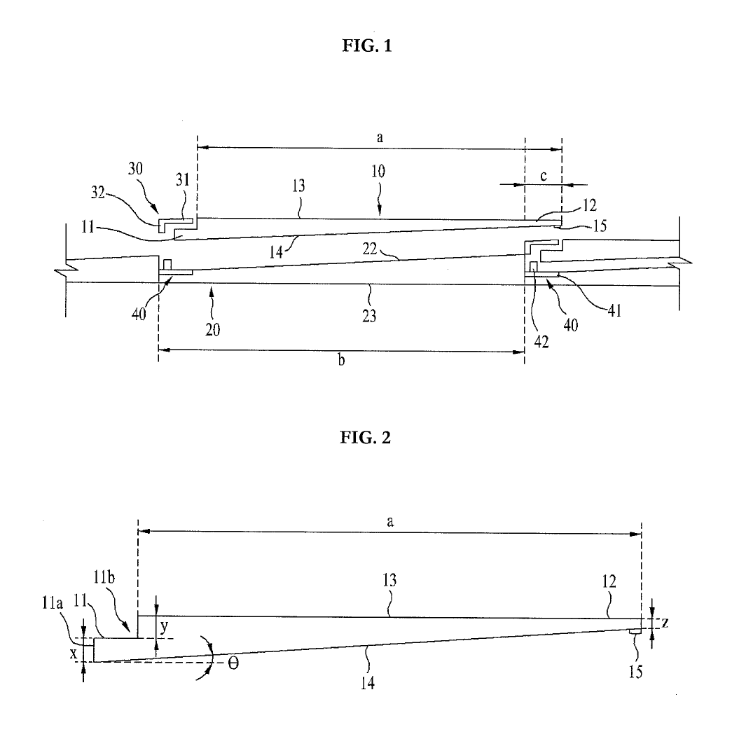

FIG. 1 shows that a back light unit includes a plurality of neighboring light guide plates 10 connected to each other and light source units 40 for irradiating light to the light guide plates 10. Each of the light guide plates 10 includes a light incidence part 11 upon which light is incident and a light emitting part 13 from which light is emitted.

The light emitting part 13 is connected to the light incidence part 11 for emitting incident light upward. A raised portion (or step) may be formed between a top of the light incidence part 11 and a top of the light emitting part 13.

The light guide plates 10 and the light source units 40 are mounted (or provided) on a frame 20. The end of the light guide plate 10 opposite to the light incidence part 11 may be provided above a light incidence part 11 of a neighboring light guide plate 10 such that there is an overlap c.

The light guide plates 10 may be arranged such that the light guide plates 10 neighbor each other, to form a plane. In this case, a light incidence part 11 provided at one end of a light guide plate 10 may partially overlap the other end of a neighboring light guide plate 10 opposite to the light incidence part 11.

That is, the other end of a light guide plate 10 having a light incidence part 11 provided at one end thereof may cover one end of a neighboring light guide plate 10 (i.e., the top of the neighboring light guide plate 10) to form a single plane through which light is emitted from the light guide plate 10.

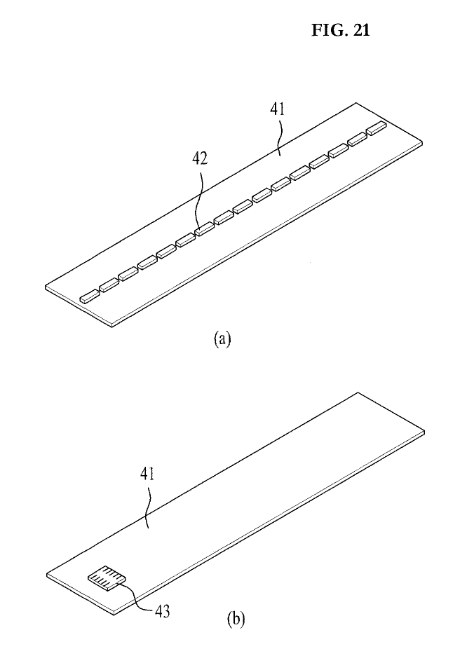

Each of the light source units 40 may be embodied by a spot light source or a light source extending in one direction, such as a fluorescent lamp. Each of the light source units 40 may include a circuit board 41 and a plurality of light sources 42 arranged on the circuit board 41 (see FIG. 21). Each of the light sources 42 may emit light at a predetermined orientation angle. The orientation angle may be an angle at which light is emitted from each of the light sources 42.

The light sources 42 may be semiconductor light emitting devices, such as light emitting diodes (LED) or laser diodes (LS) arranged at predetermined intervals.

At least one cover (or middle mold) 30 may be provided above each of the light source units 40. The cover 30 may support the light incidence part 11.

For example, assuming that neighboring boards 41 include a first board 41 and a second board, a first light source unit 40 and a second source unit 40 may be provided on the first board 41 and the second board 41, and a light incidence part 11 and a light emitting part 13 may be provided at each of the light source units 40.

The light incidence part 11 may be provided at one end of each of the light guide plates 10, and the remaining portion of each of the light guide plates 10 may constitute the light emitting part 13. One end of the light emitting part 13 opposite to the light incidence part 11 may at least partially overlap a neighboring light incidence part 11.

If neighboring light guide plates 10 include a first light guide plate 10 and a second light guide plate 10, an cover may be provided between one end of a light emitting part 13 of the first light guide plate 10 opposite to a light incidence part 11 and a light incidence part 11 of the second light guide plate 10.

More specifically, when N (N>=2) light guide plates are arranged such that the light guide plates neighbor each other, at least a portion of a light emitting part of a k-th (1<=k<=N−1) light guide plate may be provided above a light incidence part of a (k+1)-th light guide plate, and an cover may be provided between a bottom of the light emitting part of the k-th light guide plate and the light incidence part of the (k+1)-th light guide plate.

Each of the covers 30 may cover a corresponding light source unit 40 and a top of a light incidence part of a corresponding light guide plate 10.

The light incidence part 11, upon which light is incident, of each of the light guide plates 10 may have a shape protruding toward a corresponding light source unit 40. The top of the light incidence part 11 may have a lower height than a plane of each of the light guide plates 10 constituting the light emitting part 13.

As shown in FIG. 2, the light incidence part 11 may include an incidence plane 11a upon which light is incident and a raised portion part 11b (or step part or a ledge) provided at an upper side of the incidence plane 11a to form a ledge together with the light emitting part 13. The incidence plane 11a and the surface 11c are side surfaces of the light guide plate 10. The sides surfaces of the light guide plate have prescribed elevations, x, y, and z, where x+y>z, and/or x<=y or x>=y, and/or x>=z or y>=x. Further, each of the side surfaces are shown to have a plane perpendicular to the light emitting part 13 and the ledge 11b. As can be appreciated, such features may be adjusted or varied by one of ordinary skill based on the present disclosure.

The light incidence parts 11 may protrude lengthily from the corresponding light emitting parts 13 constituting an effective screen of the back light unit, thereby removing darkness caused due to gaps between the light sources 42. Light may be prevented (or reduced) from directly leaking from the light sources 42 through joints between the light guide plates 10.

Each of the light guide plates 10 may be constructed in a structure in which light beams incident upon the light incidence part 11 from the corresponding light source unit 40 are guided while being diffused and reflected in the light guide plate 10 such that the light beams are uniformly mixed, and the mixed light beams may be emitted through the light emitting part 13.

The outside main plane of each of the light guide plates 10 may constitute a single light emitting plane, and such light emitting planes may be continuously repeatedly arranged by a predetermined length a by the connected light guide plates 10, thereby providing a large-sized light emitting plane.

According to design conditions, light guide plates 10 having different sizes may be arranged. Repeated lengths a of the light guide plates 10 may be different from each other.

Each of the light guide plates 10 may include a portion that has a gradually decreasing thickness from one end to the other end thereof. Each of the light guide plates 10 may be configured such that the thickness of each of the light guide plates 10 may gradually decrease as the distance increases from the light incidence part 11. The angle of inclination θ may determine the size of the light guide plante 10. Assuming that the dimensions of x, y and z are the same, a light guide plate having a smaller angle of inclination is larger than a light guide plate having a larger angle of inclination. Further, the dimensions of x, y and z may vary. Like wise, the dimensions of a, b and c may vary. The light guide plate may be transparent. For example, e.g., the light guide plate may be formed of one of acryl-based resin such as polymethyl metaacrylate (PMMA), polyethylene terephthlate (PET), poly carbonate (PC), and polyethylene naphthalate (PEN). The light guide panel 15 may be formed using an extrusion molding method.

The thickness of each of the light guide plates 10 may decrease as the distance from the light incidence part 11 increases, and the bottom 14 of each of the light guide plates 10 may be inclined in one direction. Each of the light guide plates 10 may be constructed such that the thickness of each of the light guide plates 10 gradually decreases as the distance from the light incidence part 11 increases.

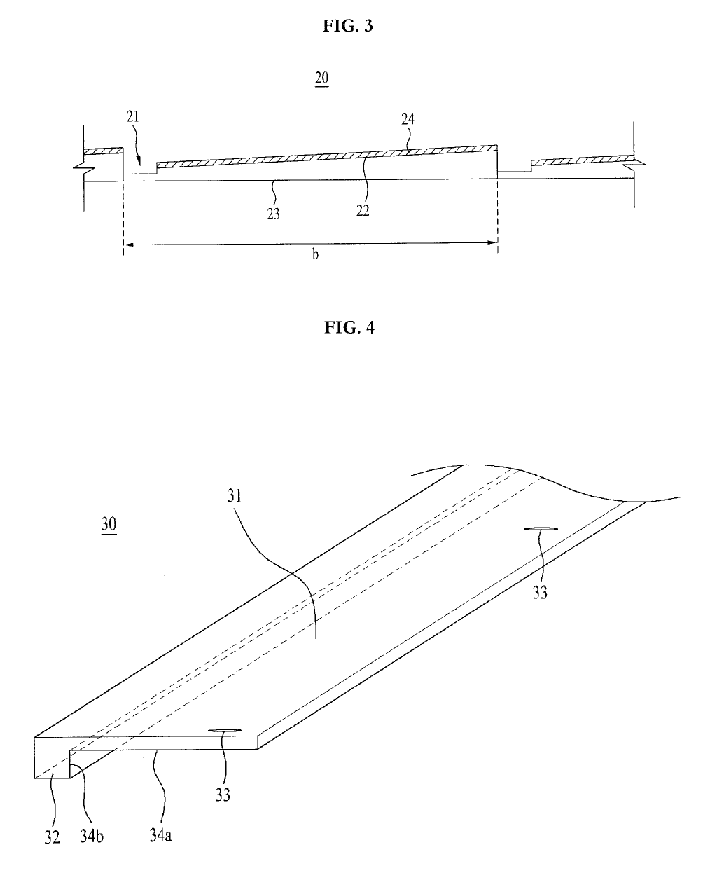

As shown in FIG. 3, the frame 20, on which the light guide plates 10 are provided, may have a second-direction inclined plane having an inclination opposite to a first-direction inclined plane of each of the light guide plates 10. When the light guide plates 10 are provided on the frame 20, the two inclined planes 14 and 22 may be coupled to or contact each other such that the light guide plates 10 and the frame 20 have a uniform thickness.

The light guide plates 10 may be placed (or mounted) directly on the frame 20, which may be made of stainless steel, aluminum and/or plastic. When each of the light guide plates 10 and the frame 20 are stacked, the top 13 of each of the light guide plates 10 and the bottom 23 of the frame 20 are parallel to each other.

On the other hand, the frame 20 may be further provided at the inclined plane 22 on which each of the light guide plates 10 may be mounted with a reflection member 24. The frame 20 may be formed of a reflective material, such as metal, rather than providing such a reflection member 24. The frame 20 may have a reflection plane or a reflection layer from which light is reflected.

The reflection member 24 may be provided at the bottom of each of the light guide plates 10. Alternatively, the reflection member 24 may be provided between each of the light guide plates 10 and the inclined plane 22 of the frame 20 as an additional layer.

As shown in FIG. 3, the frame 20 may have coupling parts 21 in each of which a corresponding one of the light source units 40 may be coupled such that each of the light source units 40 is coupled in each of the coupling parts 21 of the frame 20. That is, the light source units 40 may be coupled to the frame 20 in a state in which the circuit board 41 of each of the light source units 40 is mounted to the frame 20.

The coupling parts 21 and the second-direction inclined planes 22 of the frame 20 may be repeatedly arranged by a predetermined length b. In particular, the inclined planes 22 may be repeatedly arranged by a same width of each of the light guide plates 10.

On the other hand, the inclined planes 22 may be repeatedly arranged by different lengths b when light guide plates 10 having different sizes are arranged.

A plurality of light guide plates 10 may be provided on the frame 20 such that the light guide plates 10 are connected to each other at predetermined intervals. A large-sized back light unit may be constructed by mounting the light guide plates 10 on the frame such that the light guide plates 10 are connected to or contact each other.

FIG. 4 is a perspective view illustrating an example of the cover 30. Other embodiments and configurations may also be provided. The cover 30 may prevent a light source unit 40 provided in a light incidence part 11 between a light guide plate 10 and a neighboring light guide plate 10 from directly emitting light to a screen of the back light unit.

A reflection member for reflecting light may be provided at a plane (e.g., surface 34a and/or surface 34b) of the cover 30 corresponding to the light sources 42 of the light source unit 40. That is, the cover 30 may be formed of a reflective material or a reflective material may be coated on the surface of the cover 30 such that light from the light source unit 40 is reflected by the reflective material and is incident upon the light incidence part 11, thereby improving reflective incidence efficiency.

The cover 30 may include a first member 31 to cover the light source unit 40 and the top of the incidence part 11 and a second member 32 bent and extending from the first member 31 such that the second member 32 is provided at one side of the light source unit 40.

The cover 30 may be provided on the light incidence part 11 to block light from the light incidence part 11.

The end 12 of the neighboring light guide plate 10 (i.e., the end 12 of the neighboring light guide plate 10 opposite the incidence part 11) may be provided at the top of the cover 30. Light diffused and emitted by the light guide plates 10 may not be interrupted by the cover 30, thereby achieving continuous emission of uniform light. Further, the cover 30 may also include a reflective layer provided on a top surface 31.

The cover 30, provided between the connected light guide plates 10 may prevent the light sources 42 from emitting light to the screen of the back light unit, thereby improving light incidence efficiency. Further, the cover 30 may not cover the adjacent light emitting part 13 and bright and dark lines may be prevented (or reduced) from being generated at an interface between the connected light guide plates 10 and reduce darkness of the light incidence part 11 due to the raised portion (or step) of the light incidence part 11.

The end 12 of the light guide plate 10 opposite to the incidence part 11 may be coupled on the cover 30. That is, a protrusion 15 may be provided at the bottom of the end 12 of each of the light guide plates 10 (see FIGS. 1 and 2), and as shown in FIG. 4, the cover 30 may be provided with recesses or grooves 33 in each of which the protrusions 15 of each of the light guide plates 10 is coupled. When a plurality of light guide plates 10 are continuously coupled to a plurality of covers 30 on the frame 20 in a neighboring state, the coupled state therebetween may not be affected by impact and/or vibration. The shape of the recesses or grooves 33 and the protrusions may vary, but are likely to be complementary in shape such that the protrusions 15 may fit into the grooves 33. Further, the protrusions and recesses my facilitate alignment of each light guide relative to an adjacent light guide plate.

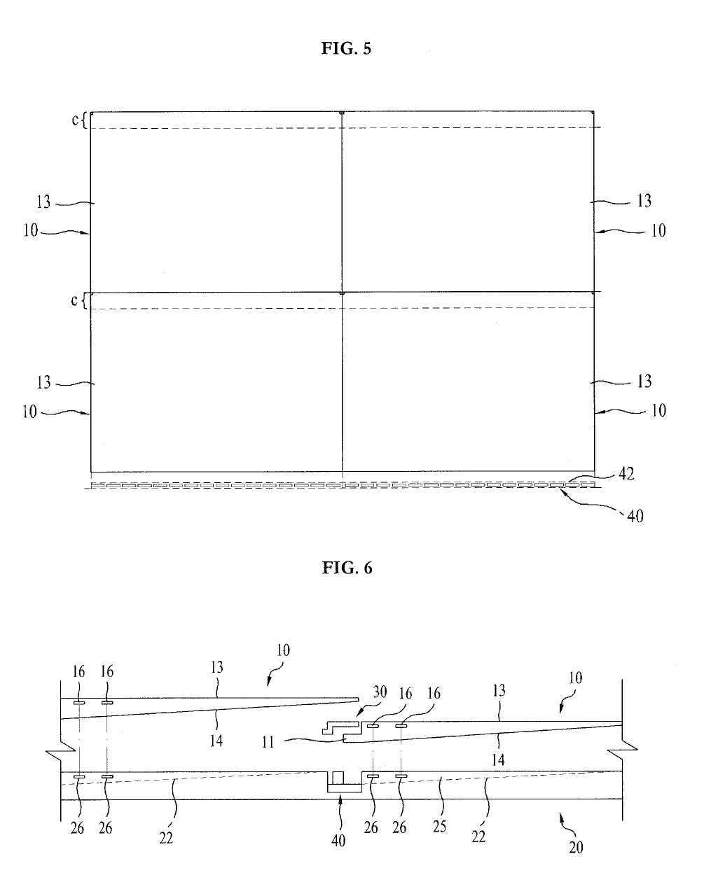

The light guide plates 10, the covers 30, and the light source units 40 may be connected on the frame 20 in a neighboring state to provide a large-sized light emitting plane as shown in FIG. 5. FIG. 5 illustrates a light emitting plane constituted by four light guide plates 10. However, a light emitting plane of a desired size may also be provided by coupling or fitting an appropriate number of the light guide plates 10.

The light emitting part 13 of the light guide plate 10 may not be interrupted but may be connected to the light emitting part 13 of a neighboring light guide plate 10. A uniform light emitting plane may be achieved by coupling a plurality of light guide plates 10 to each other in a neighboring state.

In this embodiment, a thin back light unit may be manufactured using the light guide plates 10. In addition, the lower frame 20 may be integrally manufactured, thereby simplifying the assembly process and weight of the back light unit.

The light guide plates 10 may be connected to each other in a tiled manner, thereby improving reliability in manufacturing a large-sized back light unit. Further, local dimming may be applied in which the light source units 40 are partially driven according to a picture, thereby providing a screen having a high contrast ratio.

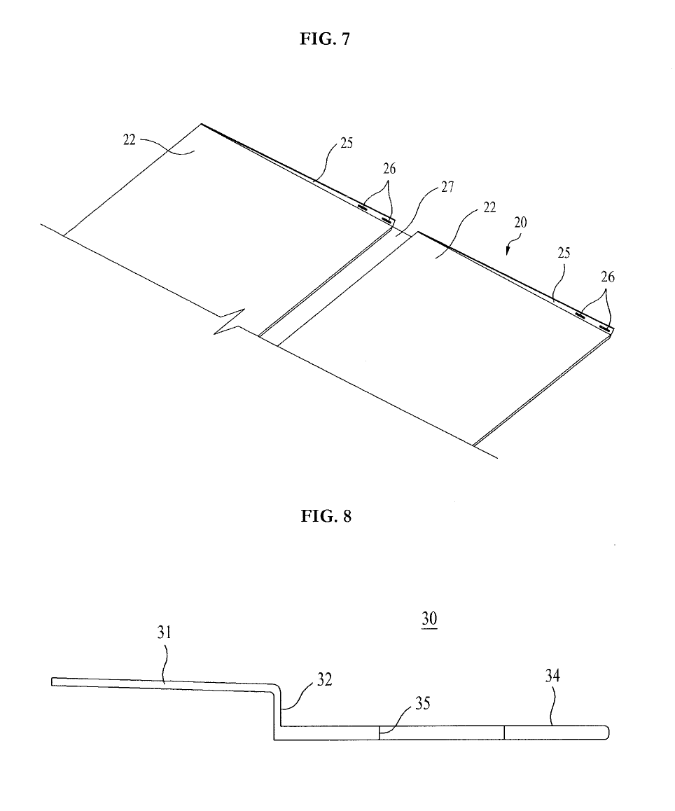

FIGS. 6 and 7 illustrate a back light unit according to another embodiment of the present disclosure. Other embodiments and configurations may also be provided. In this embodiment, the back light unit may include a plurality of neighboring light guide plates 10 connected to each other and light source units 40 for irradiating light to the light guide plates 10. Each of the light guide plates 10 may include the light incidence part 11 upon which light is incident and the light emitting part 13 from which light is emitted.

The light guide plates 10 and the light source units 40 may be mounted (or provided) on the frame 20. Each of the light guide plates 10 may be coupled to a corresponding edge part 25 provided at the frame 20.

The edge part 25 may function as a reflection plate. At least a portion of the side of each of the light guide plates 10 may be covered by the corresponding edge part 25 of the frame 20. When a light guide plate 10 is coupled to a neighboring light guide plate 10, transmission of light from the light guide plate 10 to the neighboring light guide plate 10 may be minimized.

When the light source units 40 are driven in a divided manner, a brightness effect may be improved. Bright and dark lines may be prevented (or reduced) from being generated at the interface between the respective light guide plates 10 and darkness of the light incidence part 11 may be reduced due to the raised portion (or step) of the light incidence part 11. Uniformity of light emitted through the light guide plates 10 may be improved.

At least one coupling hole 26 may be formed in the edge part 25. Each of the light guide plates 10 may have a latch part or clip 16 configured to be coupled in the coupling hole 26. The light guide plates 10 may be more securely coupled to the frame 20 by the coupling between the coupling hole 26 and the latch part 16.

The latch part 16 may be formed in the shape of a coupling protrusion or a hook. FIGS. 6 and 7 illustrate an example in which two latch parts 16 and two coupling holes 26 are provided at one side of each of the light guide plates 10 and the corresponding region of the frame 20 adjacent to the corresponding light source unit 40.

On the other hand, as shown in FIG. 7, the frame 20 may be provided with light source installation parts 27 in each of which a corresponding one of the light source units 40 are provided.

The cover 30 may be formed in a shape bent twice such that the cover 30 may be more securely assembled on the light incidence part 11 of the corresponding light guide plate 10 and the corresponding light source unit 40.

The concrete shape and coupling relation of the cover may now be described.

As shown in FIG. 8, the cover 30 may include a first member 31 to cover the top of the light source unit 40, a second member 32 bent and extending from the first member 31 such that the second member 32 is provided at one side of the light source unit 40, and a third member 34 bent from the second member 32. The first member 34 may have a fixing hole 35. The third member 34 may form a raised portion (or step) together with one end of the cover 30 and may correspond to a board 41.

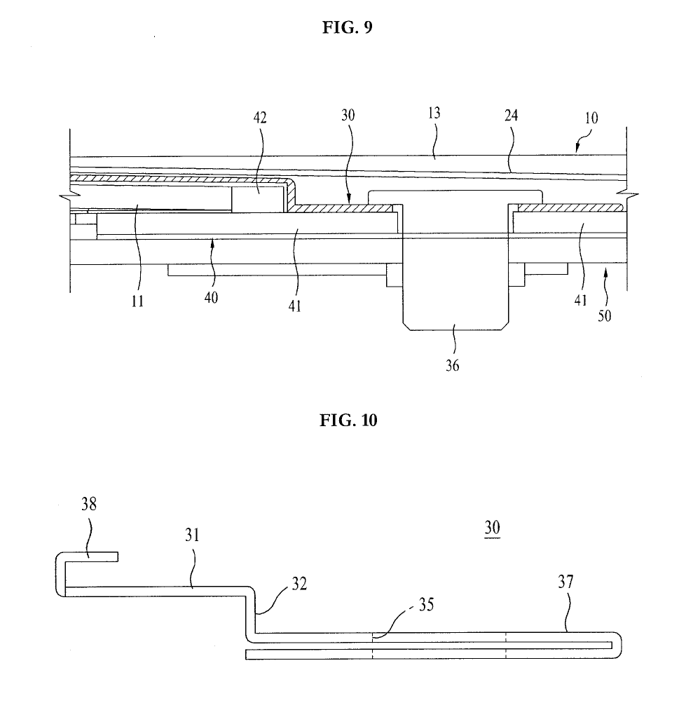

As shown in FIG. 9, the cover 30 may be coupled to a lower cover 50 by inserting a coupling member, such as a screw or a rivet 36, through the board 41 of the light source unit 40 via the fixing hole 35 of the third member 34. A plurality of first holes may be formed in the board 41 such that coupling members are coupled in the first holes, and second holes corresponding to the first holes may be formed in the cover 30 such that the coupling members are inserted through the second holes.

A space defined by the first member 31 and the second member 32 of the cover 30 may cover the light incidence part 11 of the corresponding light guide plate 10 and the light sources 42 of the light source unit 40 for optically isolating the light sources 42 and the light incidence part 11 from the light emitting part 13. The third member 34 may couple the cover 30.

The screw 36 for coupling the cover 30 may also serve to fix (or attach) the board 41 of the light source unit 40.

The coupling between the cover 30 and the light guide plate 10 may be achieved by boss-type coupling or adhesion, for example, using an adhesive tape. The cover 30 may be formed of plastic or metal, such as aluminum.

On the other hand, as shown in FIG. 10 the cover 30 may include a latch part 38 and a fourth member 37. The latch part 38 may be formed at one end of the first member 31 covering the top of the light source unit 40. The latch part 38 may be latched between neighboring light guide plates 10 to fix (or attach) the cover 30. The fourth member 37 may be bent from one end of the second member 32 in a twofold structure. The fourth member 37 may have a fixing hole 35.

A space defined by the first member 31 and the second member 32 of the cover 30 may cover the light incidence part 11 of the corresponding light guide plate 10 and the light sources 42 of the light source unit 40 for optically isolating the light sources 42 and the light incidence part 11 from the light emitting part 13. The fourth member 37 may couple the cover 30.

Adhesion layers 17 may be further provided at the top and bottom of the light incidence part 11 for reinforcing the coupling with the light source unit 40 and the cover 30.

Two or more latch parts 38 may be provided. The latch parts 38 may diverge from one end of the first member 31 or may be formed at predetermined intervals.

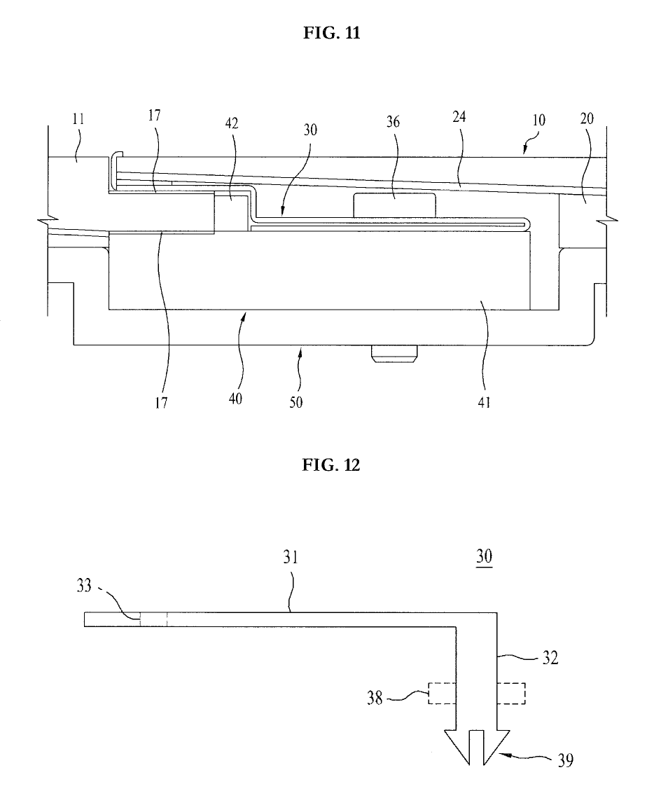

A screw 36 for coupling the cover 30 may fix (or attach) the board 41 of the light source unit 40, in the same manner as the previous example. As shown in FIG. 11, the cover 30 may be coupled to a lower cover 50 by inserting a coupling member, such as the screw 36, through the board 41 of the light source unit 40 via the fixing hole 35 of the fourth member 37.

The lower cover 50 may be formed of a same member as the frame 20 to which the light guide plate 20 is coupled or to a member different than the frame 20.

The cover 30 shown in FIG. 12 may have a similar construction to the cover 30 shown in FIG. 4. That is, the cover 30 may include a first member 31 to cover the top of the light source unit 40 and a second member 32 bent and extending from the first member 31 such that the second member 32 is provided at one side of the light source unit 40.

The first member 31 may include a groove 33 in which the protrusion 15 (FIG. 1) provided at the end 12 of the light guide plate 10 opposite to the light incidence part 11 is coupled. At one end of the second member 32 a hook 39 may be provided for coupling with the frame 20 or the lower cover 50. Further second member may optionally include a tab protrusion 38 such a prescribed height is created between the first member 31 and the bent portion 32 to cover the light source 42.

The cover 30 may be made of a plastic material, such as polycarbonate. The cover 30 may be formed by injection molding.

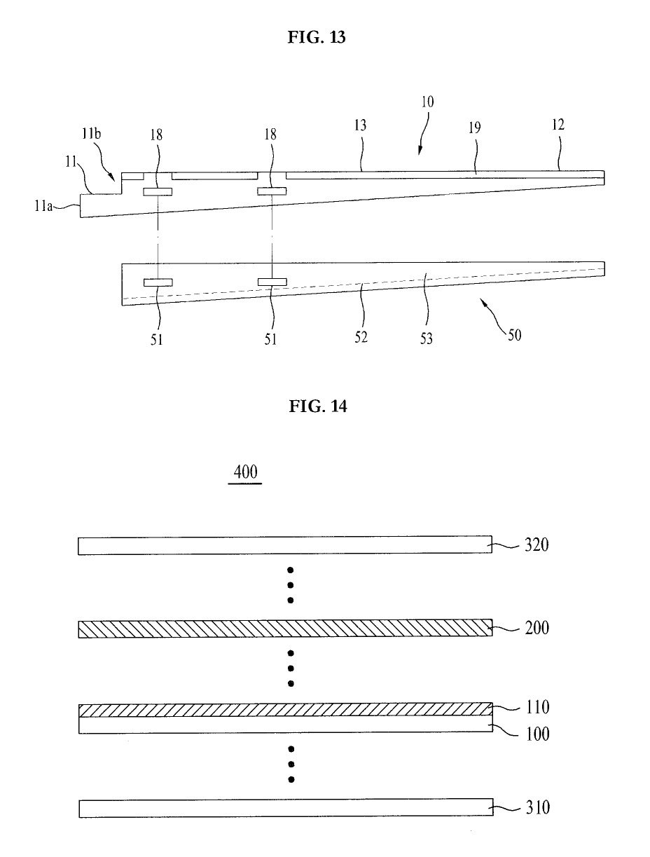

The reflection member provided between the light guide plate 10 and the frame 20 may be embodied by an additional reflection plate 50 coupled to the light guide plate 10 as shown in FIG. 13.

The coupling between the light guide plate 10 and the reflection plate 50 may be achieved by a coupling member, such as a hook. For example, an edge part 53 may be provided at least one side of the reflection plate 50, and the light guide plate 10 may be coupled to the edge part 53 of the reflection plate 50. One or more coupling holes 51 may be provided at the edge part 53 of the reflection plate 50, and coupling protrusions 18 may be provided at the light guide plate 10 such that the coupling protrusions 18 may be coupled in the coupling holes 51. Consequently, secure coupling between the light guide plate 10 and the reflection plate 50 may be achieved without an additional coupling device.

The coupling achieved by using the coupling holes 51 and the coupling protrusions 18 may improve workability, enabling easy manufacture of a light guide plate module including the light guide plate 10 and the reflection plate 50 coupled to each other, and additionally maintaining the coupled state between a plurality of the light guide plates 10 after the light guide plates 10 are coupled to each other.

A coupling extension 19 may be provided at the edge of the light guide plate 10 on the light emitting part 13 side such that the coupling extension 19 is latched to the end of the edge 53.

The coupling extension 19 may be provided above the end of the edge part 53. A coupling extension 19 of a neighboring light guide plate 10 may be connected to the coupling extension 19, and therefore continuity of light may be prevented (or reduced) from being interrupted due to the edge part 53. That is, in a structure in which light guide plates 10 are connected to each other in a neighboring state, the edge part 53 may not be visible when viewed from the light emitting side. When the light guide plate 10 and the reflection plate 50 are coupled to each other in this way, the bottom 14 of the light guide plate 10 may contact a reflection plane provided at the bottom 52 of the reflection plate 50, thereby improving emission efficiency of light emitted from the light guide plate 10. As shown in FIG. 14, a display panel 200 may be provided on the described back light unit (hereafter denoted by reference numeral 100) to construct a display device 400. The display device 400 may include a drive unit (not shown) for supplying drive power to the light source units 40 or the display panel 200 from an external power supply. The back light unit 100 may be covered by a lower cover 310 and an upper cover 320 may be provided on the display panel 200 for covering the top of the display panel 200. The back light unit may be provided at the bottom of the display panel 200. A plurality of optical sheets 110 may be provided on the back light unit 100 for controlling brightness properties of light emitted from the back light unit 100. The optical sheets 110 may be provided at the bottom of the display panel 200. The optical sheets 110 may include a diffusion sheet, a prism sheet, and/or a protection sheet. The diffusion sheet may serve diffuse light emitted from the back light unit 100 and supply the diffused light to the display panel 200. The prism sheet may have triangular micro prisms formed on the top thereof in a predetermined array. The prism sheet may serve to condense light diffused by the diffusion sheet in a direction perpendicular to a plane of the display panel 200. The micro prisms formed on the prism sheet may have a predetermined angle. Most of the light, having passed through the prism sheet, may advance perpendicularly to provide uniform brightness distribution. The uppermost protection sheet may protect the prism sheet, which has low scratch resistance.

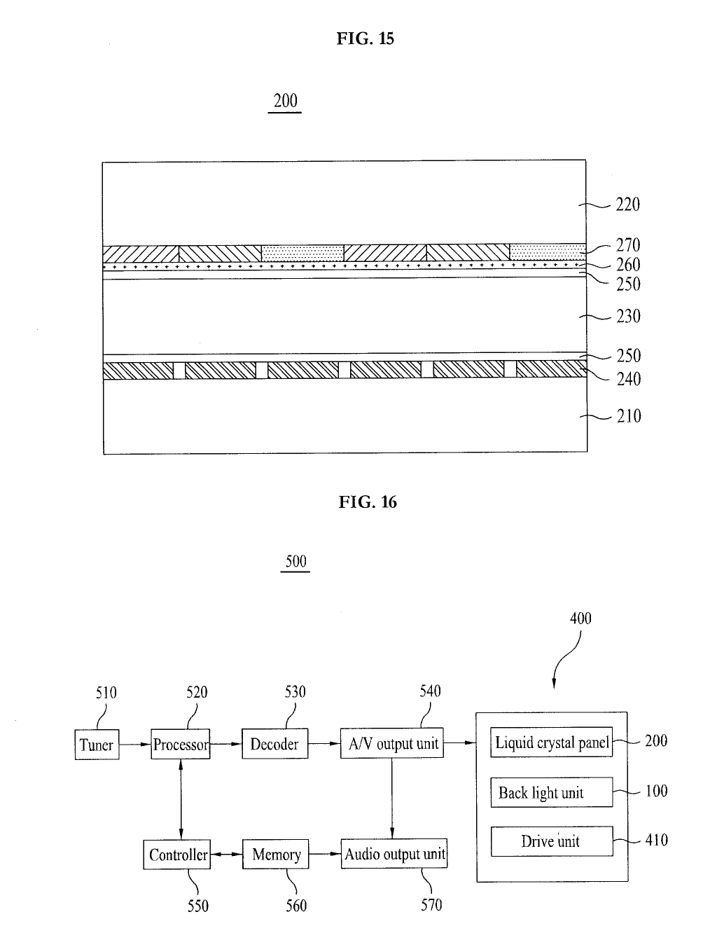

As shown in FIG. 15, the display panel 200, provided on the back light unit 100, may include upper and lower substrates 210 and 220 facing each other and a liquid crystal layer 230 provided between an upper substrate 210 and a lower substrate 220 as shown in FIG. 15. The back light unit 100 may be provided at the bottom of the display panel 200. The back light unit 100 may be divided into a plurality of blocks configured to be individually driven.

The display panel 200 may include liquid crystal cells, constituting pixels, arranged in a matrix pattern. The display panel 200 may form a picture by adjusting light transmissivity of the liquid crystal cells based on picture signal information transmitted from the drive unit.

The drive unit may include a flexible printed circuit board FPC, a drive chip mounted in the flexible printed circuit board, and a printed circuit board connected to one side of the flexible printed circuit board. The optical sheets 110 may be provided at the bottom of the display panel 200. The optical sheets 110 may include a diffusion sheet, a prism sheet, and/or a protection sheet. The diffusion sheet may serve diffuse light emitted from the back light unit 100 and supply the diffused light to the display panel 200. The prism sheet may have triangular micro prisms formed on the top thereof in a predetermined array. The prism sheet may serve to condense light diffused by the diffusion sheet in a direction perpendicular to a plane of the display panel 200. The micro prisms formed on the prism sheet may have a predetermined angle. Most of the light, having passed through the prism sheet, may advance perpendicularly to provide uniform brightness distribution. The uppermost protection sheet may protect the prism sheet, which has low scratch resistance.

As shown in FIG. 15, the lower substrate 210 of the display panel 200 may have a plurality of gate lines and a plurality of data lines arranged in a matrix pattern. Pixel electrodes and thin film transistors (TFT) 240 may be formed at intersections between the gate lines and the data lines.

A signal voltage applied through the thin film transistors 240 may be supplied to the liquid crystal layer 230 by the pixel electrodes. The liquid crystal layer 230 may be aligned according to the signal voltage to decide light transmissivity.

Color filters 270 may be formed at the upper substrate 220 having RGB pixels that reveal predetermined colors when light is transmitted through the RGB pixels and a common electrode 260 made of a transparent conductive material, such as indium tin oxide (ITO) or indium zinc oxide (IZO). Orientation films 250 may be provided at the top and bottom of the liquid crystal layer 230.

Performance of the display device 400 with the above-described construction may be increased and/or maximized through use of the back light unit 100.

A liquid crystal television may be constructed using the display device 400.

The liquid crystal television may be constructed as shown in FIG. 16. A broadcasting data stream received from a tuner 510 may be transmitted to the display device 400 via a processor 520, a decoder 530, and an A/V output unit 540 such that the broadcasting data stream is displayed on the display device 400.

The operation of the tuner 510 or the processor 520 may be controlled by a controller 550. The controller 550 may include a memory 560.

When a user selects a broadcasting channel by manipulating the liquid crystal television with the above-described construction, the controller 550 may control the tuner 510 to tune in to the selected broadcasting channel, and control the processor 520 to divide a data stream of a broadcasting program provided through the tuned broadcasting channel into audio and video data and to output the divided audio and video data.

The decoder 530 may decode the data output from the processor 520 into audio and video signals. The audio and video signals may be output to the display device 400 or an audio output unit 570, such as a speaker unit, through the A/V output unit 540.

The back light unit 100 may be driven through the drive unit 410 to display a screen output to the display panel 200.

The broadcasting data stream transmitted to the processor 520 may be provided through the Internet.

Another embodiment of a back light unit and a display device using the same may be described in detail with reference to the accompanying drawings.

This embodiment may differ from previous embodiments shown in FIGS. 1 to 16 in terms of a coupling structure between an cover and a light guide plate. Same components of this embodiment as the previous embodiments may not be described.

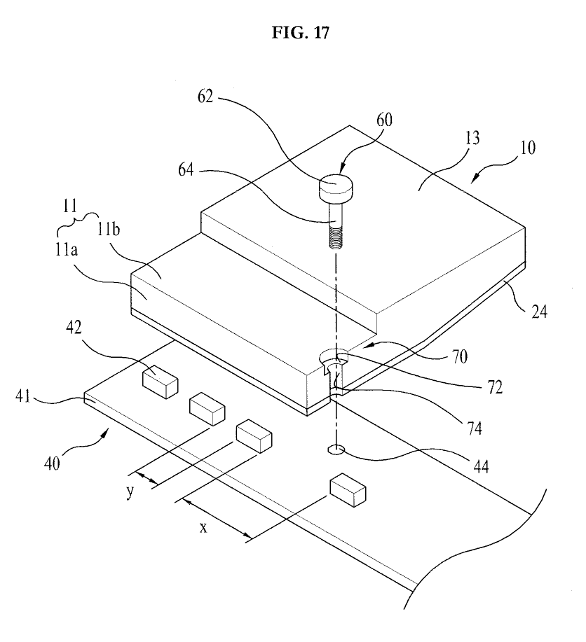

FIG. 17 is a partial perspective view illustrating an example of fastener. Other embodiments and configurations may also be provided.

As shown in FIG. 17, a back light unit may include a plurality of neighboring light guide plates 10 connected to each other, light source units 40 for irradiating light to the light guide plates 10, and an fastener 60 for fixing or attaching the light guide plates 10. The fastener 60 may be provided on the light incidence part to attach the light guide plate 10 to a frame 20 or a board 41. The fastener may be a screw or a rivot and other appropriate type of fasteners. The fastener may also be an adhesive.

Each of the light guide plates 10 may include the light incidence part 11 upon which light is incident and the light emitting part 13 from which light is emitted. Each of the light source units 40 may be embodied by a spot light source or a light source extending in one direction, such as a fluorescent lamp.

Each of the light source units 40 may include a circuit board 41 and a plurality of light sources 42 arranged on the circuit board 41. The light sources 42 may be semiconductor light emitting devices, such as light emitting diodes (LED) or laser diodes (LS) arranged at predetermined intervals.

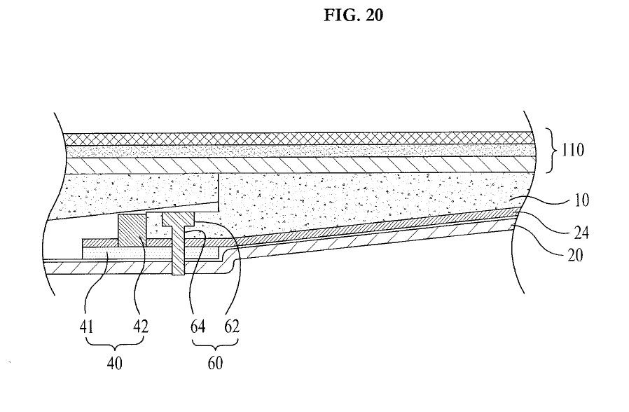

Each of the light sources 42 may include a light emitting plane, provided on the board 41, having a yellow fluorescent substance coated on a blue light emitting diode having a wavelength of 430 nm to 480 nm and a plurality of leads. The board 41 may be provided on the frame 20 as shown in FIG. 20.

The light incidence part 11, upon which light is incident, of each of the light guide plates 10 may have a shape protruding toward a corresponding light source unit 40. The top of the light incidence part 11 may have a lower height than a plane of each of the light guide plates 10 constituting the light emitting part 13.

The light incidence part 11 may include an incidence plane 11a upon which light is incident and a raised portion part 11b (or step part) or a ledge provided at the upper side of the incidence plane 11a to form a ledge together with the light emitting part 13.

The light incidence parts 11 may protrude lengthily from the corresponding light emitting parts 13 constituting an effective screen of the back light unit, thereby removing (or reducing) darkness caused due to gaps between the light sources 42. Light may be prevented (or reduced) from directly leaking from the light sources 42 through joints between the light guide plates 10.

Each of the light guide plates 10 may be constructed in a structure in which light beams incident upon the light incidence part 11 from the corresponding light source unit 40 are guided while being diffused and reflected in the light guide plate 10 such that the light beams are uniformly mixed, and the mixed light beams are emitted through the light emitting part 13.

The outside main plane of each of the light guide plates 10 may constitute the light emitting part 13, and such light emitting parts 13 may be continuously repeatedly arranged by a predetermined length a by the connected light guide plates 10, thereby providing a large-sized light emitting plane.

Light guide plates 10 having different sizes may be arranged. In this case, repeated lengths a of the light guide plates 10 may be different from each other.

Each of the light guide plates 10 may be configured such that a thickness of each of the light guide plates 10 gradually decreases as the distance increases from the light incidence part 11, and the bottom 14 of each of the light guide plates 10 is inclined in one direction. Each of the light guide plates 10 may be constructed such that the thickness of each of the light guide plates 10 gradually decreases as the distance increases from the light incidence part 11. A reflection member 24 may be further provided at the bottom of each of the light guide plates 10.

Each of the light guide plates 10 may be configured such that the thickness of each of the light guide plates 10 does not gradually change from one side to the other side thereof, but opposite ends of each of the light guide plates 10 may have different thicknesses.

For example, the thickness of one end of each of light guide plates 10 at which the light incidence part 11 is provided may be greater than the thickness of the other end of each of light guide plates 10 opposite to the light incidence part 11.

The fastener 60 may be provided at the interface between every two neighboring light guide plates 10. The fastener 60 may cover a portion of the top of the light incidence part 11.

The fastener 60 may be in tight contact with the tops of the neighboring light incidence parts 11 at the interface between the neighboring light guide plates 10 to fix or attach the light incidence parts 11. More specifically, the fastener 60 may be coupled to the frame 20 or the board 41 in tight contact with the tops of the respective light guide plates 10 between the two light guide plates 10 to fix or attach the light guide plates 10.

The fastener 60 may have a structure similar to a bolt used to fix building materials or mechanical parts. The fastener 60 may include a head part 62 configured to contact the tops of the neighboring light incidence parts 11 and a protrusion part 64 configured to be coupled into the frame 20 or the board 41 through a space defined between the light incidence parts 11.

The head part 62 and the protrusion part 64 may support the light incidence parts 11 and fix or attach the fastener 60, respectively. The head part 62 and the protrusion part 64 may have different diameters.

The head part 62 may be formed in the shape of a disc or a cylinder. However, the head part 62 may be formed in the shape of a polygon, such as a triangle, quadrangle, pentagon or hexagon.

Each of the light guide plates 10 may be provided with an insertion part 70 corresponding to the fasteners. The insertion part 70 may be formed at the two neighboring light incidence parts 11 in a separated state. That is, the insertion part 70, into which the fastener 60 is inserted, may be formed by tight contact between the two neighboring light incidence parts 11.

The insertion part 70 may include a first insertion part 72, formed so as to correspond to the shape of a portion of the head part 62, depressed in the tops of the light incidence parts 11 by a predetermined depth and a second insertion part 74 extending vertically through the light incidence parts 11 such that the protrusion part 64 is inserted into the second insertion part 74.

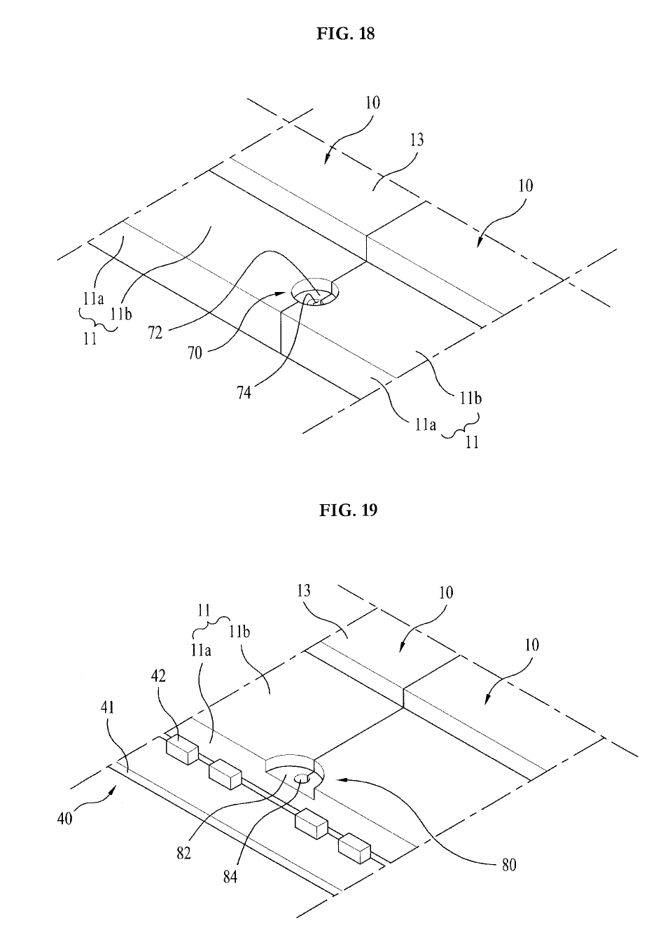

FIG. 18 is a partial perspective view illustrating an embodiment of an insertion part.

As shown in FIG. 18, the first insertion parts 72 and the second insertion parts 74 may be formed so as to face each other at the interface between two neighboring light incidence parts 11, and the neighboring first insertion parts 72 and the neighboring second insertion parts 74 may cooperate with each other to form a space in which the fastener 60 is coupled.

The head part 62 of the fastener 60 may be located in the neighboring first insertion parts 72. The neighboring second insertion parts 74 may cooperate with each other to form a through hole through which the protrusion part 64 is inserted.

More specifically, the fastener 60 may be located in the first insertion parts 72 of the respective light incidence parts 11. Consequently, two neighboring light incidence parts 11 may be fixed or attached by one fastener 60.

The second insertion parts 74 and the through hole formed by coupling between the second insertion parts 74 may not necessarily be distinguished from each other, but may designate substantially the same construction. A first insertion part 72 and a pair of first insertion parts 72 may have a same meaning. A second insertion part 74 and a pair of second insertion parts 74 may have the same meaning.

The thickness of the head part 62 may be equal to or less than the depth of the first insertion part 72 such that the top of the head part 62 may be provided in or on a same plane as the top of the light incidence part 11 or below the top of the light incidence part 11.

The first insertion parts 72 formed in the light incidence parts 11 may be open toward the neighboring light incidence parts 11 at sides of the light incidence parts 11. That is, the first insertion parts 72 may be depressed in the facing sides of the neighboring light incidence parts 11 and the facing tops of the neighboring light incidence parts 11 in the shape of a semicircle. The fastener 60 may not be exposed toward the light source unit 40.

FIG. 19 is a partial perspective view illustrating an embodiment of an insertion part.

The structure of the first insertion parts 72 may be variously changed based on design conditions. As shown in FIG. 19, first insertion parts 82 may be foimed at corners of the light incidence parts 11 such that the first insertion parts 82 are open toward light source units 40 and the neighboring light incidence parts 11. More specifically, the first insertion parts 82 may be provided at corners of the light incidence parts 11 defined by the sides facing the neighboring light incidence parts 11, the sides facing the light source units 40, and the tops of the neighboring light incidence parts 11.

On the other hand, a screw hole 44, into which the protrusion part 64 of the fastener 60 is coupled, may be formed in the board 41 corresponding to the second insertion parts 74 of the light incidence parts 11. Based on design conditions, however, the protrusion part 64 of the fastener 60 may be coupled to the frame 20, and not to the board 41. Alternatively, the protrusion part 64 of the fastener 60 may be inserted through the frame 20, and a nut may be coupled to the protrusion part 64 of the fastener 60 at the bottom of the frame 20. The fastener 60 may attach the light guide plate 10 to the frame 20 or the board 41.

The light sources 42 may be arranged such that the distance x between two light sources 42 most adjacent to the second insertion parts 74 is greater than the distance y between the remaining light sources 42. In this arrangement, the amount of light in the light incidence parts 11 interfering with or lost by the fastener 60 may be reduced, and a space for a circuit pattern lost due to the screw hole 44 may be further secured.

FIG. 20 is a partial sectional view illustrating the structure of the light guide plate attached by the fastener 60.

FIG. 20 shows that the head part 62 of the fastener 60 is located in the first insertion part 72 through the interface between the neighboring light incidence parts 11. The protrusion part 64 of the fastener 60 is inserted through the light incidence parts 11, the reflection member 24, the board 41, and the frame 20, and is then fixed or attached.

In the structure in which the fastener 60 is provided at the interface between the neighboring light incidence parts 11 to fix or attach the light guide plates 10 as described above, two light guide plates 10 may be attached using one fastener 60. The fastener 60 may be inserted into the light incidence parts 11, and therefore, the fastener 60 may not occupy an additional space, thereby improving spatial utilization.

Although described as an attachment member, the above-described cover 30 may also be referred to as a light incident blocking member, a blocking and fixing member, a blocking member and/or a shield. The fastener 60 may attach a light guide plate to a frame, block light from a light incidence part and/or attach a light guide plate to a board, for example. At least one embodiment of the present disclosure may include use of both the cover 30 and the fastener 60.

Hereinafter, a back light unit according to another embodiment of the present disclosure and a display unit including the same will be described in detail with reference to the accompanying drawings.

This embodiment is identical to the embodiment illustrated in FIGS. 1 to 20 except a structure in which light sources and light guide plates are mounted, and therefore, a detailed description of the same components is omitted.

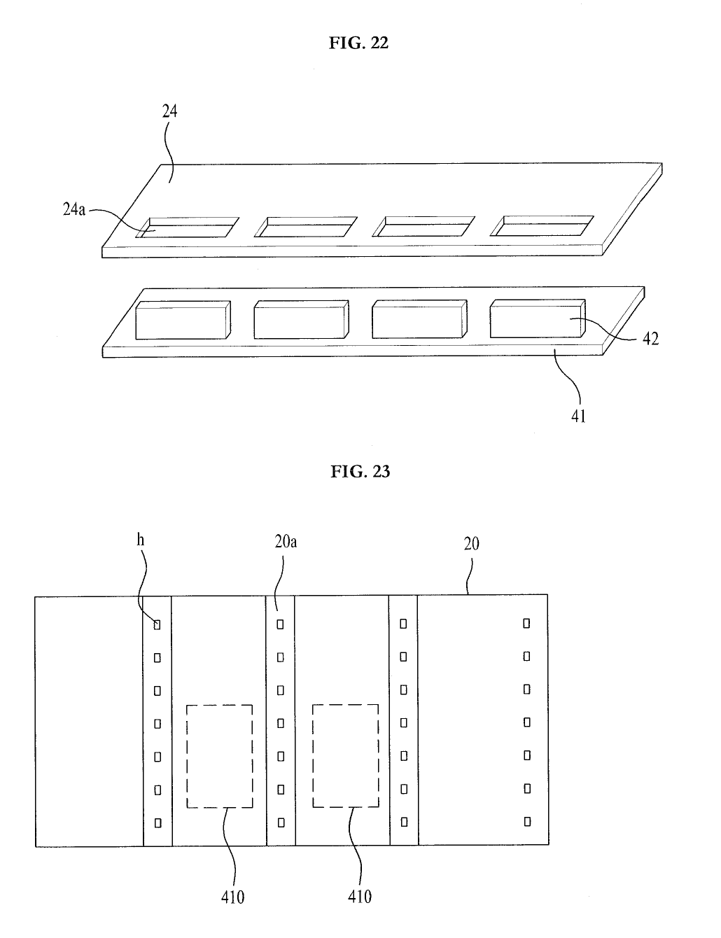

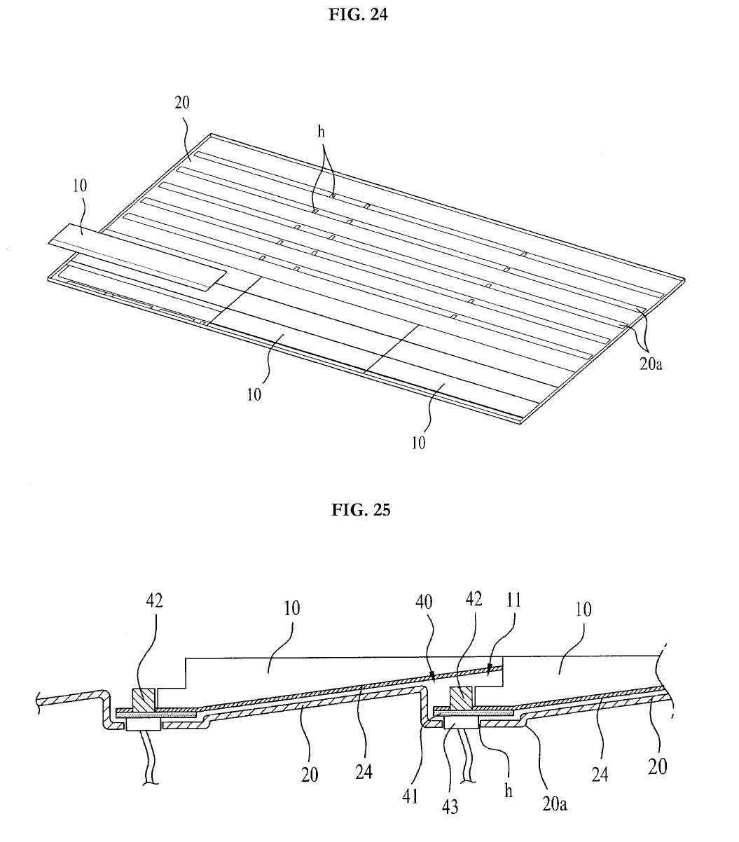

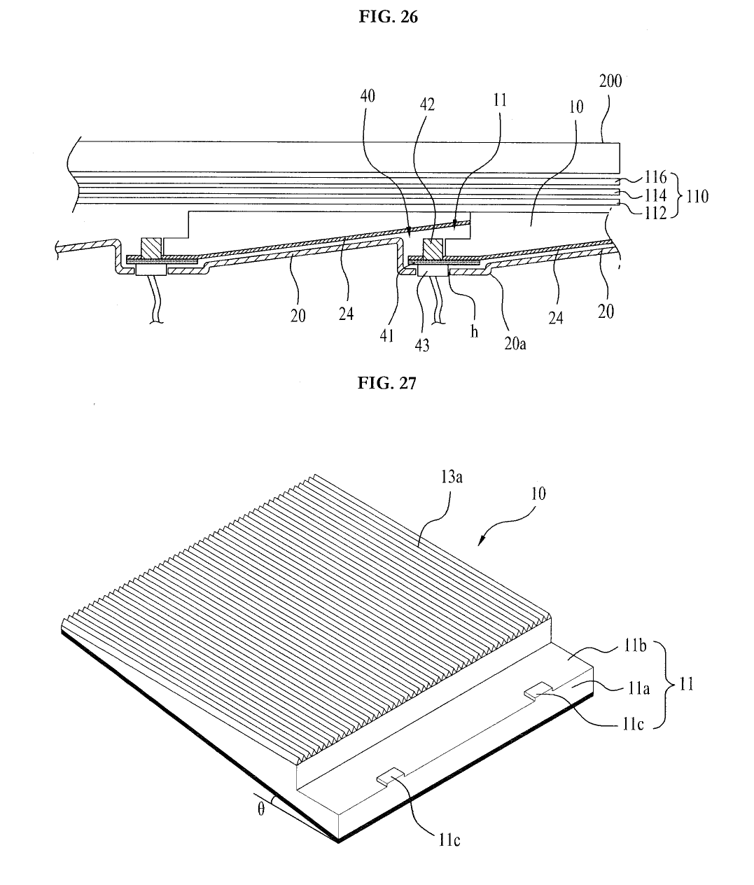

FIG. 21 is a perspective view illustrating the structure of a light source unit, FIG. 22 is a perspective view illustrating arrangement of the light source unit and a reflection member, FIG. 23 is a plan view illustrating the structure of a frame, FIG. 24 is a perspective illustrating the structure of a back light unit, FIG. 25 is a view illustrating arrangement of light guide plates and light source units mounted to the frame, FIG. 26 is a view illustrating a relationship between the back light unit and optical sheets, and FIG. 27 is a perspective view illustrating another embodiment of a light guide plate.

Referring to FIG. 21, a light source unit 40 may include a circuit board 41, a plurality of light sources 42 arranged on the circuit board 41, and a connector for supplying power to the circuit board 41 on the opposite side.

Referring to FIG. 22, a plurality of through holes 24a may be formed in a reflection member 24. The through holes 24a correspond to the light sources 42. The light sources 42 protrude from one side of the reflection member 24 through the through holes 24a. The reflection member 24 is located at the circuit board 41 and extends to the light guide plate.

Referring to FIG. 23, a frame 20 at which pluralities of light guide plates 10 and light source units 40 are located may be configured in the form of a plate having an area corresponding to a liquid crystal panel 200. A recess 20a may be formed at the frame 20. The circuit board 41 is located at the recess 20a.

The recess 20a may extend along one side of the frame 20. A plurality of recesses may be provided to correspond to the light guide plates 10. A plurality of circuit boards 41 may be disposed at each recess 20a so as to correspond to the length of the recess 20a

The recess 20a is provided with holes h through which the circuit boards 41 are exposed outside and for the connector 43. The recess 20 may be bent perpendicularly from the main plane of the frame 20 to form a step. The frame 20 may be provided with a drive unit. The drive unit controls various components using an electric signal. In this embodiment, a back light drive unit 410 is described as an example. The back light drive unit 410 is operatively connected to the display panel 200 for controlling the driving of a back light unit 100. The drive unit 410 is provided on an opposite side of the frame 20 from the light guide plates.

Referring to FIG. 24, a plurality of light guide plates 10 are disposed on the frame 20, while adjoining one another, to provide a large-area light emitting surface. The light guide plates 10 are individually driven. The light guide plates 10 not only form a uniform light emitting surface but also partially drive the light source units 40 according to images. Consequently, local dimming or local turn off is possible.

Referring to FIG. 25, the light source unit 40 may be located each recess 20a of the frame 20, and the connector 43 of each circuit board 41 may be exposed from the bottom of the frame 20 through the corresponding hole h of the frame 20. The connectors 43 may be electrically connected to the back light drive unit 410 provided around the frame 20.

The reflection member 24 is located at the circuit board 41 of each light source unit 40. The light sources 42 are placed at the top of the reflection member 24 through the reflection member 24. The light guide plates 10 are disposed at the frame 20 such that light incidence parts 11 face the light sources 42. At this time, a plurality of light guide plates may be arranged, while adjoining one another, to constitute a single plane. The light incidence part 11 provided at one end of each light guide plate 10 and the other end of the light guide plate 10, which is the side opposite to the light incidence part 11, partially overlap with the light incidence part 11 of a neighboring light guide plate 10.

The other end of each light guide plate 10 having the light incidence part 11 provided at one end thereof may cover one end of a neighboring light guide plate 10, i.e., the top of the neighboring light incidence part 11, to constitute a single plane. At this time, the light source 42 and the light incidence part 11 may be spaced apart from each other by a predetermined distance.

Referring to FIG. 26, a plurality of optical sheets 110 may be provided on the back light unit 100 for controlling brightness properties of light emitted from the light guide plates 10. The optical sheets 110 may be provided at the bottom of the display panel 200. The optical sheets 110 may include a diffusion sheet 112, a prism sheet 114, and a protection sheet 116.

The diffusion sheet 112 may serve to diffuse light emitted from the back light unit 100 and supply the diffused light to the display panel 200. The prism sheet 114 may have triangular micro prisms formed on the top thereof in a predetermined array. The prism sheet 114 may serve to condense light diffused by the diffusion sheet in a direction perpendicular to a plane of the display panel 200.

The micro prisms formed on the prism sheet 114 may have a predetermined angle. Most of the light, having passed through the prism sheet 114, may advance perpendicularly to provide uniform brightness distribution. The uppermost protection sheet 116 may protect the prism sheet 114, which has low scratch resistance.

Referring to FIG. 27, each light guide plate 10 may be configured in the form of a prism wherein a plurality of light emitting parts 13a for emitting light are arranged in lines while adjoining one another based on design conditions. Each of the light emitting parts 13a is configured approximately in the form of a trigonal prism, and extends from one end to the other end of the light guide plate 10. Each light emitting part 13a has a sectional area gradually decreased in the protruding direction, with the result that a corner is formed at the top of each light emitting part 13a. The prism-shaped light emitting pats 13a disposed in lines, while adjoining one another, guide light incident upon the light incidence part 11 from one end to the other end of the plate light guide plate 10, thereby minimizing light loss and improving light transmission efficiency. Also, the light incident part 11 may be provided with catching parts 11c to prevent the movement of an cover 30 based on design conditions.

Embodiments of the present disclosure may provide a back light unit wherein a light guide plate is used to improve optical properties. The back light unit may be manufactured as a thin type, and a total weight of the back light unit may be reduced.

Embodiments of the present disclosure may include a back light unit wherein light guide plates are connected to each other in a tiled manner, thereby improving reliability, application of a large-sized light guide plate, and achieving a high contrast ratio through local dimming.

Embodiments of the present disclosure may include a back light unit wherein nonuniformity of light, including bright and dark lines generated between light guide plates, may be improved.

Embodiments of the present disclosure may provide a back light unit including a board, a light source disposed on the board, a plurality of light guide plates and an attachment member (or middle mold) disposed on the light incidence part. The light source may include a light emitting diode for emitting light having a wavelength of 430 nm to 480 nm and a fluorescent substance coated on the light emitting diode. The plurality of light guide plates may be disposed in a neighboring state, and each of the light guide plates may comprise a light incidence part upon which light is incident and a light emitting part from which light is emitted upward. One side of the light emitting part may be connected to the light incidence part.

Embodiments of the present disclosure may include a back light unit including one or more boards, a plurality of light sources disposed on the boards for emitting light at a predetermined orientation angle, N (N>=2) light guide plates and an attachment member (or middle mold). Each of the light guide plates may comprise a light incidence part having an incidence plane upon which light is side-incident from the respective light sources and a light emitting part from which light is emitted upward One side of the light emitting part may be connected to the light incidence part. Additionally, at least a portion of a light emitting part of a k-th (1<=k<=N−1) light guide plate, from among the N light guide plates, may be provided above a light incidence part of a (k+1)-th light guide plate. The attachment member (or middle mold) may be provided between a bottom of the light emitting part of the k-th light guide plate and the light incidence part of the (k+1)-th light guide plate.

Embodiments of the present disclosure may include a display device including a display panel, a drive unit for supplying drive power to the display panel, and a back light unit provided at a bottom of the display panel. The back light unit may be divided into a plurality of blocks to be individually driven. The back light unit may include one or more boards, a plurality of light sources may be provided on the boards for emitting light at a predetermined orientation angle, N (N>=2) light guide plates and an attachment member (or middle mode). Each of the light guide plates may comprise a light incidence part having an incidence plane upon which light is side-incident from the respective light sources and a light emitting part from which light is emitted upward. One side of the light emitting part may be connected to the light incidence part. Additionally, at least a portion of a light emitting part of a k-th (1<=k<=N−1) light guide plate, from among the N light guide plates, may be provided above a light incidence part of a (k+1)-th light guide plate. The attachment member (or middle mold) may be provided between a bottom of the light emitting part of the k-th light guide plate and the light incidence part of the (k+1)-th light guide plate.

Embodiments may have the following effects.

In constructing a back light unit, light guide plates may be manufactured so as to have a small size, light sources may be provided at sides of the light guide plates, and the respective light guide plates may be connected to each other. Consequently, a sufficient amount of light may be secured to constitute the back light unit and to scatter heat.

The light sources provided at the sides of the light guide plates may be optically hidden, thereby preventing (or reducing) the light sources from irradiating a screen side of the back light unit and improving light incidence efficiency. In addition, bright and dark lines may be prevented (or reduced) from being generated at an interface between the connected light guide plates and darkness of a light incidence part of each of the light guide plates may be reduced due to a raised portion (or step) formed at the light incidence part.

Module type light guide plates may be mounted on an integrated frame, thereby greatly reducing thickness and weight of the back light unit.

A reliability-related problem of the back light unit may be solved and a high contrast ratio may be achieved through local dimming.

An attachment member coupled to an interface between neighboring light incidence parts may be in tight contact with tops of the light incidence parts, thereby achieving secure fixing of the neighboring light guide plates and thus preventing the light guide plates from being separated from the frame.

The present disclosure also provides a “green” technology for display devices. Presently, the backlight is generally turned on continuously, even when the display of the entire screen is not desirable. For example, the prior art display allows control of the resolution of the entire display screen but not the size of the display screen. However, in certain instances, a smaller screen area may be desirable for lower resolution images. The size of the display area can be controlled based on the present disclosure. For example, instead of viewing images and programs in 42 inch display, the display screen size can be reduce to 32 inches by turning off the light sources for appropriate number of light guide plates located at the periphery of the display device. As can be appreciated, the location and size of the display area can be controlled based on program or user needs. As can be appreciated, multiple configuration may be possible based on turning on or off the light sources for appropriate number of light guide plates (light guide panels or light guide modules or assemblies) based on application and user configuration.

This application is related to Korean Applications Nos. 10-2008-0049146 filed on May 27, 2008, 10-2008-0061487 filed on Jun. 27, 2008, 10-2008-0099569 filed on Oct. 10, 2008, 10-2009-0035029 filed on Apr. 22, 2009, 10-2009-0052805 filed on Jun. 15, 2009, 10-2009-0061219 filed Jul. 6, 2009, 10-2009-0071111 filed Aug. 2, 2009, 10-2009-0072449 filed Aug. 6, 2009, 10-2009-0075120 filed on Aug. 14, 2009, 10-2009-0080654 filed Aug. 28, 2009, and 10-2009-0098844 filed on Oct. 16, 2009, whose entire disclosures are incorporated herein by reference. Further, this application is related to U.S. Provisional Patent Application Nos. 61/219,480 filed on Jun. 23, 2009; 61/229,854 filed on Jul. 30, 2009; 61/230,844 filed on Aug. 3, 2009; 61/233,890 filed on Aug. 14, 2009; and 61/237,841 filed on Aug. 28, 2009 and U.S. application Ser. Nos. 12/453,885 filed on May 22, 2009, 12/618,603 filed on Nov. 13, 2009, 12/632,694 filed on Dec. 7, 2009, and LGE-162, LGE-163, HI-0400, HI-0412, HI-0413, HI416 and HI-0420 all filed on Mar. 19, 2010, whose entire disclosures are incorporated herein by reference.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A back light unit comprising:
a plurality of light guide plates, at least one light guide plate having a light incidence part to receive light from a first direction and a light emitting part adjacent to the light incidence part to emit light received from the light incidence part in a second direction, the first and second directions being different directions;
a light source, the light source including at least one light emitting diode which emits light having a wavelength between 430 nm to 480 nm and having a fluorescent material provided on the light emitting diode such that the output light has a prescribed wavelength, the at least one light emitting diode providing the output light to the light incidence part; and
at least one of (1) at least one fastener to fasten the light incidence portion and to maintain a position of the at least on light guide plate relative to an adjacent light guide plate or (2) a cover to cover the light source.

2. The back light unit according to claim 1, wherein the fastener is directly disposed on the light incidence part to fasten the light guide plate.

3. The back light unit according to claim 1, wherein the light incidence part of includes an insertion part into which the fastener is inserted.

4. The back light unit according to claim 3, wherein the insertion part comprises a first insertion part provided on the light incidence part of the at least one light guide plate and a second insertion part provided on a light incidence part of the adjacent light guide plate.

5. The back light unit of claim 4, wherein the first insertion part and the second insertion part are provided on an edge of the at least one light guide plate and the adjacent light guide plate, respectively.

6. The back light unit according to claim 1, wherein the fastener comprises a head part and a protrusion part that protrudes from the head part.

7. The back light unit according to claim 6, wherein the head part does not protrude above a top surface of the light incidence part.

8. The back light unit according to claim 5, wherein the first insertion part and the second insertion part have complementary shape.

9. The back light unit according to claim 1, wherein the at lest one light guide plate configured to receives output light from a plurality of first light emitting diodes, the adjacent first light emitting diodes being spaced apart by a first distance, and the adjacent light guide plate configured to receive output light from a plurality of second light emitting diodes, the adjacent second light emitting diodes being spaced apart by a second distance, wherein a third distance between adjacent first and second light emitting diodes is different from the first and second distances.

10. The back light unit according to claim 9, wherein the third distance is greater than the first and second distances, which are equal.

11. The back light unit according to claim 9, wherein the fastener is provided between the adjacent first and second light emitting diodes.

12. The back light unit according to claim 1, wherein an elevation difference exists between a top surface of the light incidence part and a top surface of the light emitting part.

13. The back light unit according to claim 12, wherein the elevation of the top surface of the light emitting part is greater than the top surface of the light incidence part such that a step structure is provided between the top surfaces.

14. The back light unit according to claim 1, wherein the at least one light guide plate includes a reflection member.

15. The back light unit according to claim 1, wherein a first portion of the light emitting part of the at least one light guide plate closest to the light incidence part has a first thickness and a second portion of the light emitting part of the at least one light guide plate furthest from the light incidence part has a second thickness, the first and second thickness being different.

16. The back light unit according to claim 15, wherein the thickness of the light emitting part that gradually decreases from the first thickness to the second thickness.

17. The back light unit according to claim 1, wherein the fluorescent material is yellow phosphorous such that the output light is white light.

18. The back light unit according to claim 1, wherein the cover further covers t at least a portion of the light incidence part.

19. The back light unit according to claim 1, wherein the cover comprises:
a first member provided over a top of the light source and
a second member that is bent from the first member, the second member corresponding to a side of the light source.

20. The back light unit according to claim 19, wherein the cover further comprises a third member that is bent from the second member to form a step together with the first member.

21. The back light unit of claim 1, wherein the plurality of light guide plates comprises
N light guide plates, wherein N is equal to or greater than 2, and wherein at least a portion of a light emitting part of a k-th (1<=k<=N−1) light guide plate is disposed over a light incidence part of a (k+1)-th light guide plate.

22. A display apparatus having the back light unit of claim 1, wherein the display apparatus further comprises:
a display panel provided over the back light unit; and
a drive unit for supplying drive power to the display panel, the drive unit configured to drive the light source of the light guide plates independently.
